(19) United States
(12) Patent Application Publication
(10) Pub. No.: US 2010/0158289 A1
(43) Pub. Date: Jun. 24, 2010

(54) METHOD FOR OPERATING A HEARING AID SYSTEM AND HEARING AID SYSTEM WITH A SOURCE SEPARATION DEVICE

(75) Inventors: Frank Beck, Spardorf (DE); Ulrich Kornagel, Erlangen (DE)

Correspondence Address: LERNER GREENBERG STEMER LLP, P O BOX 2480, HOLLYWOOD, FL, 33022-2480, US

(73) Assignee: SIEMENS AUDIOLOGISCHE TECHNIK GMBH, Erlangen (DE)

(21) Appl. No.: 12/639,352

(22) Filed: Dec. 16, 2009

(30) Foreign Application Priority Data
Dec. 16, 2008 (DE) 10 2008 062 587.6

(51) Int. Cl. H04R 25/00

(52) U.S. Cl. 381/313; 381/314

(57) ABSTRACT

A method for operating a hearing aid system and a hearing aid system with a source separation device, include at least one hearing aid in which interference signals are intended to be suppressed and useful signals are intended to be accentuated with justifiable computational complexity. Source-specific reception signals are first of all generated and analyzed by the source separation device, in particular a BSS unit. Then, parameter settings for operating the hearing aid which effect the suppression of interference signals or the accentuation of useful signals are derived from the result of the analysis. An output signal generated by the hearing aid does not emerge directly from the source-specific reception signals and therefore a periodic operation of the BSS unit suffices and signal processing in real time is not necessarily required in the BSS unit.

### CROSS-REFERENCE TO RELATED APPLICATION

This application claims the priority, under 35 U.S.C. §119, of German Patent Application DE 10 2008 062 587.6, filed Dec. 16, 2008; the prior application is herewith incorporated by reference in its entirety.

### BACKGROUND OF THE INVENTION

### Field of the Invention

The present invention relates to a method for operating a hearing aid. The invention also relates to a hearing aid.

Hearing aids detect surrounding sound and supply the sound to a user in a compressed and amplified fashion. In the process, a distinction is made between useful signals and interference signals. The useful signal is the sound which the user wishes to perceive. Interference signals include all other sound impressions, irrespective of whether they are generated by the hearing aid itself (microphone noise, feedback whistle, acoustic artifacts) or whether they are part of the environment (traffic, machine noise, conversations between speakers which the user does not wish to listen to).

Since the user basically only wishes to perceive the useful signals but not the interference signals, that poses the problem of distinguishing the useful signals from the interference signals so that the useful signals can be accentuated over the interference signals by appropriate signal processing.

There are various approaches for solving the problem: by way of example, algorithms for feedback compensation, notch filters, etc. can be used to suppress the feedback whistle. Interference suppression algorithms on the basis of the Wiener filter are used, for example in order to suppress background noise from the audible surroundings of the user. The difficulty with those traditional methods is that they do not permit unambiguous identification of the interference signal and hence they always reduce an often substantial part of the useful signal in addition to the interference signal.

German Published, Non-Prosecuted Patent Application DE 101 14 015 A1 describes a method in which the hearing aid wearer can actively (e.g. by pressing a button) characterize a certain sound signal in the audible surroundings of the wearer as an interference signal or as a useful signal. The disadvantage thereof is that the sound signal recorded by the microphone is an acoustic mixed signal which includes signal components from all active sound sources in the vicinity of the user. That means that an unambiguous characterization as an interference signal or as a useful signal is not possible if the interference and useful signals occur at the same time. By way of example, the characterization of such a mixed signal as an interference signal would inevitably also lead to an undesired reduction of the useful signal, in addition to a reduction of the interference signal contained therein.

German Patent DE 103 133 31 B4, corresponding to U.S. Pat. No. 7,561,701, discloses a hearing aid with a directional microphone system suitable for determining the directions of incidence of the acoustic signals emanating from different sound sources. It affords the possibility of accentuating or suppressing certain sound sources in relation to others.

European Patent Application EP 1 848 245 A2, corresponding to U.S. Patent Application Publication No. US 2007/0253573, discloses a hearing aid with a source separation device for generating source-specific reception signals. The separation of the acoustic signals emanating from different signal sources is, for example, effected by algorithms for so-called blind source separation (BSS). The acoustic signals received by the various signal sources can subsequently be subdivided into interference signals or useful signals, possibly in consideration of manual user inputs. Ultimately, it is only the signals identified as useful signals which are then processed further and amplified.

In the case of known hearing aids with a source separation device, the high processing power required for separating the signal sources is disadvantageous. By way of example, it has a negative effect on the operating life of a hearing aid operated by a small battery.

German Published, Non-Prosecuted Patent Application DE 10 2006 020 832 A1, corresponding to U.S. Patent Application Publication No. US 2007/0269068, discloses a method for suppressing feedback, in which a predeterminable frequency range with a synthetic signal is substituted into an input signal which has a spectral component in a feedback-endangered frequency range.

### SUMMARY OF THE INVENTION

It is accordingly an object of the invention to provide a method for operating a hearing aid system and a hearing aid system with a source separation device, which overcome the hereinafore-mentioned disadvantages of the heretofore-known systems and methods of this general type and in which differing signal processing of interference signals and useful signals is possible with a relatively small amount of computational complexity.

With the foregoing and other objects in view there is provided, in accordance with the invention, a method for operating a hearing aid system having at least one hearing aid. The method comprises receiving a plurality of acoustic mixed signals from a plurality of sound sources and converting the signals into electrical mixed signals, processing at least one of the electrical mixed signals as a function of at least one parameter-setting and generating an electrical output signal, converting the electrical output signal into an output signal to be perceived by a user as an acoustic output signal, generating a plurality of source-specific reception signals from the electrical mixed signals, analyzing the source-specific reception signals, and determining the parameter-setting as a function of a result of the analysis.

With the objects of the invention in view, there is also provided a hearing aid system, comprising a hearing aid, two microphones for receiving a plurality of acoustic mixed signals from a plurality of sound sources and for converting the acoustic mixed signals into electrical mixed signals, a signal processing unit for processing at least one of the electrical mixed signals as a function of at least one parameter-setting and for generating an electrical output signal, an earpiece for converting the electrical output signal into an output signal to be perceived by a user as an acoustic output signal, a source separation device for generating a plurality of source-specific reception signals, an analysis device for analyzing the source-specific reception signals, and a parameter determination device for determining the parameter-setting for the signal processing unit as a function of a result of the analysis.

In the case of a hearing aid with a plurality of microphones, each microphone generally receives a different acoustic mixed signal which in each case results from a superposition at the location of the respective microphone of the acoustic signals generated by different sound sources. Each microphone converts the acoustic mixed signal being fed into the respective microphone into an electrical mixed signal which is then processed further and amplified to compensate for the individual loss of hearing of a user. This results in an electrical output signal which is converted into an output signal that can be perceived by the user as an acoustic signal by an output converter of the hearing aid, usually an earpiece.

In modern hearing aids, the signal processing can be adapted by a multiplicity of adjustable parameter settings within a hearing aid for the individual user or for the audible situation in which the user is located at the time. In this case, the selection of suitable parameter settings is decisive for the success the user attains with respect to an improvement of that user's hearing by using the hearing aid. In this case, this success is governed by how the respective hearing aid suppresses interference signals and accentuates useful signals—particularly in relation to the interference signals. The appropriate parameter settings for this, for example, fix the transfer functions of certain filters or determine whether or not certain algorithms, for example for interference signal suppression or for speech signal actuation, are active.

Rather than, as previously, selectively directly processing further or suppressing the source-specific reception signals, the basic concept of the invention now resides in using the source-specific reception signals for generating parameters therefrom. The parameters effect an accentuation or suppression of the respective source-specific reception signal even when the source-specific reception signals are not directly included in the output signal of the respective hearing aid.

The invention offers the advantage of now being able to generate the source-specific reception signals in a structure disposed next to the signal path of a hearing aid, in which the signal path starts at the microphones and leads to the earpiece through the signal processing unit. In contrast to the signal path, in which the signal processing has to be effected more or less in real time, time delays only play a minor role in the structure disposed next to it since, in the invention, the acoustic output signal does not arise directly from one or more source-specific reception signals during normal operation of the respective hearing aid. Hence, the computational power required for generating the source-specific reception signals can be reduced.

In a development of the invention, the computationally complex generation of the source-specific reception signals is only effected periodically and not throughout the entire operation of a respective hearing aid. Ultimately, the separation of the different sound sources is used in particular to extract certain characteristics of the interference signals and the useful signals, as a result of which the interference signals can be suppressed or the useful signals can be accentuated. Once such characteristics have been determined, the generation of the source-specific reception signals can be dispensed with for at least a limited amount of time during which the recognized interference signals or useful signals are at least mainly stationary. As a result of this, the computational power required to operate a hearing aid can be significantly reduced.

In an advantageous refinement of the invention, the hearing aid system according to the invention includes an external processor unit in addition to at least one hearing aid. The processor unit is preferably also used for remotely controlling a respective hearing aid of the hearing aid system. In this case, it is moreover possible for the computationally complex generation of a plurality of source-specific reception signals from the electrical mixed signals generated by the microphones of the hearing aid system to be effected in the external processor unit. To this end, the external processor unit is advantageously equipped with at least two microphones for generating electrical mixed signals. It is also advantageous for the analysis of the source-specific reception signals and the determination of parameter settings for the hearing aid to then be effected in the external processor unit. The parameter settings determined in the process can then be transmitted wirelessly from the external processor unit to the respective hearing aid.

In contrast to the hearing aid, the size of the equipment and the power consumption thereof only play a minor role in the external processor unit. In order to make the external processor unit easier to use, the latter can be equipped, for example, with a display and a keyboard, through the use of which, for example, the spatial distribution of a plurality of signal sources in space can be displayed graphically and the distinction between interference sound sources and useful sound sources can also be effected in consideration of user inputs.

Other features which are considered as characteristic for the invention are set forth in the appended claims.

Although the invention is illustrated and described herein as embodied in a method for operating a hearing aid system and a hearing aid system with a source separation device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block diagram of a first hearing aid system according to the invention;

FIG. 2 is a schematic and block diagram of a second hearing aid system according to the invention; and

FIG. 3 is a flowchart for a method of operating a hearing aid system according to the invention.

### DETAILED DESCRIPTION OF THE INVENTION

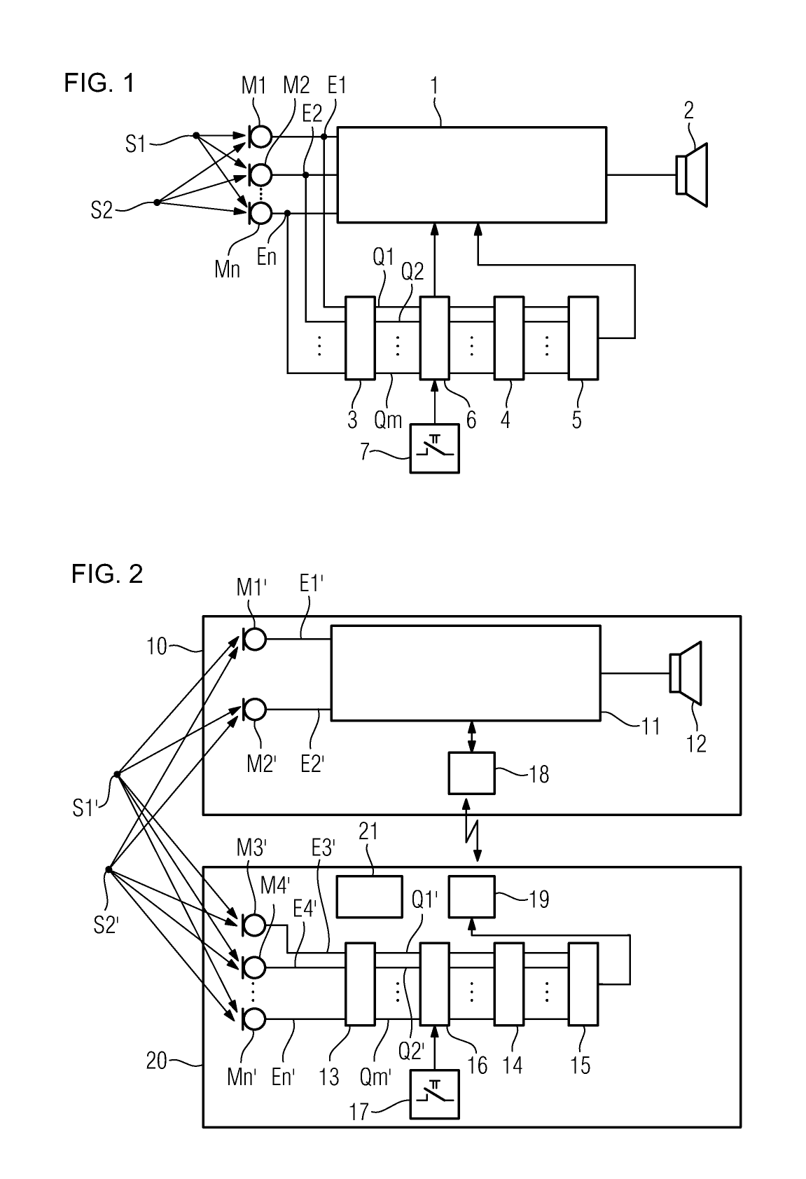

Referring now to the figures of the drawings in detail and first, particularly, to FIG. 1 thereof, there is seen a hearing aid system according to the invention which only has a single hearing aid. The hearing aid includes microphones M1, M2, . . . , Mn for recording acoustic input signals and converting the latter into electrical input signals. Moreover, in the exemplary embodiment, two signal sources 51 and S2 are present in the vicinity of the hearing aid. The sources generate a first acoustic mixed signal at an input of the microphone M1, a second acoustic mixed signal at an input of the microphone M2, etc. The microphone M1 converts the first acoustic mixed signal into a first electrical mixed signal E1 and the microphone M2 converts the second acoustic mixed signal into a second electrical mixed signal E2, etc. The electrical mixed signals E1, E2, . . . , En are processed further and amplified in a signal processing unit 1 and thus result in an electrical output signal which is converted into an acoustic output signal by an earpiece 2 and supplied to the ear of a user. In the process, the signal processing in the signal processing unit 1 can be adapted by a multiplicity of parameter settings to an individual loss of hearing of the user and to current audible surroundings in which the hearing aid is located at the time.

The hearing aid according to the invention includes a source separation device, in particular a BSS unit 3, in a signal path disposed next to the signal path between the microphones M1 to Mn and the earpiece 2, for generating a plurality of source-specific reception signals. In the exemplary embodiment with the two signal sources S1 and S2, the BSS unit 3 generates a first source-specific reception signal Q1, which basically is a result of the acoustic signal emitted by the signal source S1, and a second source-specific reception signal Q2, which basically is a result of the acoustic signal emitted by the signal source S2. The source-specific reception signals Q1, Q2, . . . , Qn are supplied to a characterization device 6 which subdivides the source-specific reception signals Q1 to Qn into interference signals or useful signals. To this end, the characterization device 6 is connected to an operating element 7 through the use of which the source-specific reception signals Q1 to Qn can be presented to the user in succession. Then, each individual source-specific reception signal is characterized as an interference signal or as a useful signal by manual actuation of the operating element 7 by the user. The source-specific reception signals classified as an interference signal or as a useful signal in this fashion are subsequently supplied to an analysis device 4 in which they are automatically analyzed with respect to certain characteristics. By way of example, the signal analysis in the signal analysis device 4 can determine a spectral analysis, an estimation of parameters of a statistical model, probability densities of spectral components (for example, real part, imaginary part and magnitude of Fourier coefficients) at different frequencies or a direction of incidence of acoustic signals into the microphone system. After analyzing the source-specific reception signals Q1 to Qn in the analysis device 4, a parameter determination device 5 automatically determines parameters suitable for the operation of the signal processing unit 1 in such a way that the source-specific reception signals characterized as interference signals are suppressed or that the source-specific reception signals characterized as useful signals are accentuated. The parameters determined in this fashion can effect the processing of the electrical mixed signals E1 to En by the signal processing unit 1 in a variety of ways. By way of example, the microphones M1 to Mm in the signal processing unit 1 can be electronically switched to form directional microphones, wherein the directional effect is then influenced by the parameters determined in the parameter determination device 5. Furthermore, the parameters can, for example, switch interference removal algorithms on or off, or can change the functionality of the latter. Furthermore, this affords the possibility of setting certain filter parameters which, for example, accentuate or suppress certain frequency bands in relation to others. Additionally, parameters based on the analysis of the interference signals or useful signals can, for example, influence the effect of an MMSE (minimum mean square error) algorithm or an Ephraim-Malah algorithm with a non-Gaussian distribution. Moreover, it is possible for parameters determined in the parameter determination device 5 to control an algorithm for restoring a speech signal in which a certain frequency range is missing or distorted and in which this frequency range is synthesized from undistorted frequency ranges.

Without a loss of generality, the examples listed only reproduce a small section of possible filters, algorithms or functions of the hearing aid which can be influenced or controlled by parameters originating from an analysis of the source-specific reception signals.

The determined parameter settings have a direct influence on the signal processing in the signal path between the microphones M1, M2, . . . , Mn and the earpiece 2, specifically in such a way that at least one interference signal is suppressed or at least one useful signal is accentuated. However, in general they do not have a direct influence on the source-specific reception signals Q1, Q2, . . . , Qm. Once these have been determined, the parameter settings determined in this fashion influence the signal processing until there is a recalculation. This can, for example, be triggered manually by the user. The generation of source-specific reception signals Q1, Q2, . . . , Qm by the hearing aid is not required during the period of time from when the parameters have been determined until the time at which a recalculation of the parameter settings is triggered. Therefore, during normal operation of the hearing aid, the computationally complex generation of the source-specific reception signals Q1, Q2, . . . , Qm is dispensed with during this period of time. In the hearing aid in accordance with the exemplary embodiment, the signals are only required for the subdivision into interference signals and useful signals and for determining the parameters for suppressing or accentuating the signals. However, they are then not required during normal operation of the hearing aid during which the parameter settings are effective.

The invention is connected to the advantage that the computationally complex determination of the source-specific reception signals, the analysis of the same and the determination of parameters based thereon, only have to be effected periodically. As long as the external situation basically remains stationary (for example, the frequency of an input signal classified as an interference signal remains unchanged), there is no need to adapt already determined parameter settings. The operation of the source separation device 3, the analysis device 4 and the parameter determination device 5 can accordingly cease periodically during the operation of the hearing aid. By way of example, the recalculation of appropriate parameters is then effected after switching on the hearing aid, after changing a program, after an automatically detected change in the audible surroundings or after a request by an appropriate manual user input.

A further advantage of the invention results from the fact that the source-specific reception signals also do not have to be generated in real time. This would only be the case if the acoustic output signal of the respective hearing aid were to arise directly from one or more source-specific reception signals. However, since this is precisely not the case within the scope of the invention, a time delay only plays a minor role in the generation of the source-specific reception signals.

It is furthermore advantageous that, in conjunction with the invention, the source-specific reception signals Q1, Q2, . . . , Qm can also be determined successively in time and subsequently be presented to the user. Hence, only one source-specific reception signal has to be determined at any one time. This also contributes to reducing the required computational power compared to a conventional hearing aid with a source separation device.

In a deviation from the illustrated exemplary embodiment, a non-illustrated alternative embodiment provides for the analysis device 4 in accordance with FIG. 1 to be connected directly behind the source separation device 3. Unlike the illustrated exemplary embodiment in accordance with FIG. 1, this can effect an automatic subdivision of the source-specific reception signals Q1 to Qn into interference signals or useful signals on the basis of the signal analysis performed in the analysis device 4. Manual user inputs for distinguishing between interference signals or useful signals are no longer necessary in this case.

The exemplary embodiment in accordance with FIG. 2 represents a further embodiment of the invention. In this case, the illustrated hearing aid system also includes an external processor 20 in addition to a hearing aid 10. The basic mode of operation of the hearing aid 10 in this case is similar to that of the hearing aid in the exemplary embodiment in accordance with FIG. 1. The hearing aid 10 in the exemplary embodiment includes two microphones M1′ and M2′ which receive acoustic signals generated by the signal sources S1′ and S2′, in the form of acoustic mixed signals. The microphones M1′ and M2′ generate electrical mixed signals E1′ and E2′ from the acoustic mixed signals. The electrical mixed signals are processed and amplified in a signal processing unit 11 in order to compensate for an individual loss of hearing of a user. The resulting electrical output signal is converted into an acoustic signal by an earpiece 12 and fed to the ear of the user. The hearing aid 10 according to the exemplary embodiment also allows for the signal processing within the signal processing unit 11 to be adapted to the individual loss of hearing of the user or to the current audible surroundings in which the hearing aid 10 is located at the time, by a multiplicity of adjustable parameters.

The external processor unit 20, which is provided in addition to the hearing aid 10 in the hearing aid system of the exemplary embodiment in accordance with FIG. 2, in particular is constructed as a remote control for operating the hearing aid 10. In addition to the usual components of a remote control for a hearing aid, the remote control 20 also includes microphones M3′, M4′, . . . , Mn′. These microphones also record acoustic mixed signals resulting from the acoustic signals emanating from the signal sources S1′ and S2′. The acoustic mixed signals are converted into electrical mixed signals E3′, E4′, . . . , En′ by the microphones M3′, M4′, . . . , Mn′ and are supplied to a source separation device 13, in particular a BSS unit. The latter generates the source-specific reception signals Q1′, Q2′, . . . , Qn′ from the electrical mixed signals E3′, E4′, . . . En′ and in the exemplary embodiment with two signal sources S1′ and S2′ accordingly generate the source-specific reception signals Q1′ and Q2′.

Similarly to the exemplary embodiment in accordance with FIG. 1, two different options for further processing of the source-specific reception signals are also available in the exemplary embodiment in accordance with FIG. 2. On one hand, these can automatically be analyzed in an analysis device 14 and can be subdivided into interference signals or useful signals. On the other hand, this subdivision can also be effected in consideration of user inputs. For this purpose, the external processor unit 20 provides a characterization device 16, through the use of which manual user inputs for subdividing the source-specific reception signals into interference signals or useful signals in conjunction with an operating element 17 are possible. In addition to the operating element 17, further non-illustrated components of the external processor unit 20 can be available for this purpose, which ease the subdivision into interference signals or useful signals. By way of example, the external processor unit can determine the spatial distribution of the sound sources in space and illustrate it graphically on a display. Furthermore, the external processor unit 20 can also include a loudspeaker and therefore the user can listen to the individual sound sources individually and separately from one another. This makes the subdivision into interference signals or useful signals much easier for the user.

Once the subdivision into interference signals or useful signals has been effected, the source-specific reception signals are analyzed with respect to the presence of certain characteristics. These include, in particular, the direction of incidence of the acoustic signals generated by the respective sound sources into the external processor unit 20, the frequency spectrum of the signals, possibly modulation frequencies contained therein, etc. Suitable parameters for the operation of the signal processing unit 11 of the hearing aid 10 are then determined in a parameter determination device 15 on the basis of the characteristic properties of the source-specific reception signals determined in this fashion. These parameter settings relate, in particular, to the method of operation (directivity) of the microphone system of the hearing aid 10 or to the method of operation of certain filters and algorithms. In order to permit the determined parameter settings to become effective, they have to be transferred from the external processor unit 20 to the hearing aid 10. To this end, the hearing aid 10 and the external processor unit 20 each include a respective transmission and reception unit 18 and 19. Furthermore, the external processor unit 20 includes a controller 21 which controls and monitors procedures and states within the external processor unit 20.

Like the hearing aid according to the exemplary embodiment of FIG. 1, the mode of operation of the hearing aid system in accordance with FIG. 2 also differs from a conventional hearing aid with a BSS unit, particularly in that the generated source-specific reception signals are mainly used to determine parameter settings. In contrast thereto, in conventional hearing aids with a BSS unit, at least one of the generated source-specific reception signals is used directly to directly generate the electrical and acoustic output signal therefrom. The disadvantage thereof is that the BSS unit has to be permanently operational, whereas according to the invention, a periodic operation of the BSS unit suffices. As long as nothing significant changes in the external audible situation, the operation of a hearing aid according to the invention can be effected with the determined parameter settings without the source-specific reception signals having to be generated continuously for this purpose. As a result of this, a significant portion of computational power can be saved compared to a conventional system with a BSS unit.

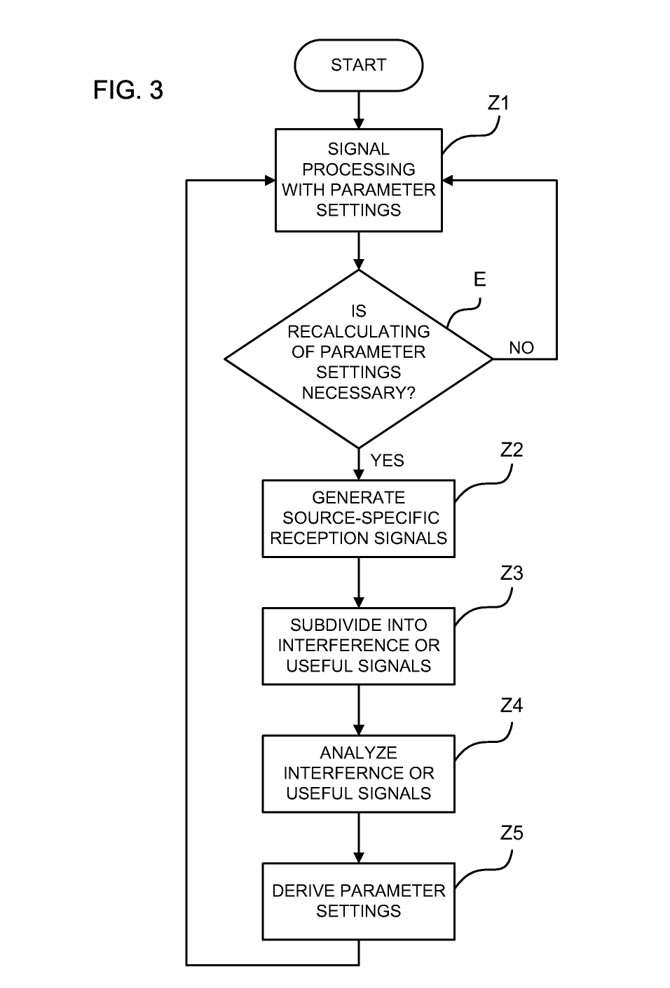

In order to make the invention even clearer, the important method steps of a method according to the invention for operating a hearing aid system are once again highlighted in conjunction with FIG. 3. After initializing, e.g. after switching on a respective hearing aid, operation is first of all effected in a state Z1 in which the signal processing in the hearing aid operates by using certain, predetermined parameter settings. Subsequently, a check is made as to whether or not a recalculation of parameter settings is necessary. In the flowchart in accordance with FIG. 3, this is illustrated by a symbol E. Triggers for a recalculation of parameter settings include, for example, a program switch in the respective hearing aid or a change from a first audible situation into a second audible situation recognized by the hearing aid. If a recalculation of parameter settings is intended to take place, the hearing aid changes into a state Z2 in which source-specific reception signals are generated. Starting from the state Z2, there is a subdivision of the individual source-specific reception signals into interference signals or useful signals in the state Z3. In particular, this subdivision can be effected in consideration of manual user inputs. In a subsequent state Z4, the source-specific reception signals characterized as interference signals or useful signals are analyzed. In the process, certain characteristic properties of the respective signals are respectively determined. In a subsequent operational state Z5, parameter settings for operating the respective hearing aid are then derived therefrom. The parameter settings are used to suppress the acoustic output signals of a signal source thereby characterized as an interference signal source in the hearing aid and the settings are used to accentuate the signals in the hearing aid originating from a signal source characterized as a useful signal source. This is then followed again by a transition into the operating state Z1 in which, however, the operation of the hearing aid is now effected with the newly determined parameter settings. In particular, source-specific reception signals are neither generated nor analyzed in the state Z1.

1. A method for operating a hearing aid system having at least one hearing aid, the method comprising the following steps:
receiving a plurality of acoustic mixed signals from a plurality of sound sources and converting the signals into electrical mixed signals;
processing at least one of the electrical mixed signals as a function of at least one parameter-setting and generating an electrical output signal;
converting the electrical output signal into an output signal to be perceived by a user as an acoustic output signal;
generating a plurality of source-specific reception signals from the electrical mixed signals;
analyzing the source-specific reception signals; and
determining the parameter-setting as a function of a result of the analysis.

2. The method according to claim 1, which further comprises respectively characterizing the source-specific reception signals as an interference signal or as a useful signal.

3. The method according to claim 2, which further comprises carrying out the characterization in consideration of user inputs.

4. The method according to claim 2, wherein the parameter-setting effects a reduction of an interference signal.

5. The method according to claim 2, wherein the parameter setting effects an accentuation of a useful signal.

6. The method according to claim 1, wherein the step of generating the source-specific reception signals from the electrical mixed signals is not effected in real time.

7. The method according to claim 1, which further comprises, after determining the parameter-setting for at least one period, carrying out the signal processing as a function of the determined parameter-setting and ceasing the generation and analysis of the source-specific reception signals.

8. A hearing aid system, comprising:
a hearing aid;
two microphones for receiving a plurality of acoustic mixed signals from a plurality of sound sources and for converting the acoustic mixed signals into electrical mixed signals;
a signal processing unit for processing at least one of the electrical mixed signals as a function of at least one parameter-setting and for generating an electrical output signal;
an earpiece for converting the electrical output signal into an output signal to be perceived by a user as an acoustic output signal;
a source separation device for generating a plurality of source-specific reception signals;
an analysis device for analyzing the source-specific reception signals; and
a parameter determination device for determining the parameter-setting for said signal processing unit as a function of a result of the analysis.

9. The hearing aid system according to claim 8, wherein the source-specific reception signals or signals resulting therefrom are configured to be supplied to the user in succession, and a characterization device of the hearing aid system is configured for characterizing a respective source-specific reception signal as an interference signal or as a useful signal by the user.

10. The hearing aid system according to claim 9, wherein said characterization device is configured for an automatic characterization of the source-specific reception signals as an interference signal or as a useful signal.

11. The hearing aid system according to claim 8, wherein said source separation device and said parameter determination device are configured to be operated periodically during operation of the hearing aid system and the signal processing is effected as a function of the parameter setting, at least also in a period during which the generation of source-specific reception signals ceases.

12. The hearing aid system according to claim 8, wherein:
said hearing aid includes said microphones, said signal processing unit, said earpiece, said source separation device, said analysis device and said parameter determination device; and
a signal path between said microphones and said earpiece has at least two signal pick-up points for generating two pick-up signals and feeding the pick-up signals to said source separation device for generating the source-specific reception signals from the pick-up signals.

13. The hearing aid system according to claim 8, which further comprises at least one external processor unit in which said source separation device and said analysis device are disposed.
